(19) United States
(12) Patent Application Publication
(10) Pub. No.: US 2019/0010897 A1
(43) Pub. Date: Jan. 10, 2019

(54) GAS STEEL CYLINDER STRUCTURE FOR CARS

(71) Applicant: ALEX GLOBAL TECHNOLOGY, INC., TAINAN CITY (TW)

(72) Inventor: WEI-CHIN CHEN, TAINAN CITY (TW)

(21) Appl. No.: 15/643,731

(22) Filed: Jul. 7, 2017

(51) Int. Cl. F02M 21/02; F17C 1/00; F17C 13/06

(52) U.S. Cl. CPC F02M 21/0221; F02M 21/0212; F17C 1/00; F17C 13/06; F17C 2270/0178; F17C 2203/0639; F17C 2205/0311; F17C 2221/035; F17C 2260/011; F17C 2201/0104

(57) ABSTRACT

A gas steel cylinder structure for cars is disclosed. It comprises a gas steel cylinder having an inner cylinder body and an outer cylinder body integrally formed thereof, wherein the inner cylinder body is provided with a through hole for communicating with the outer cylinder body.

### BACKGROUND OF THE INVENTION

### 1. Field of the Invention

The present invention relates to a gas steel cylinder structure for cars which has structural strength and no air leaks in use.

### 2. Description of Related Art

Recently, due to environmental and economic factors, liquefied petroleum gas (LPG) having much complete combustion than gasoline is primarily used as vehicle fuels in Japan, the United States, Australia, South Korea, Italy, the Netherlands and other countries for saving energy. Unlike the past that people deemed the modified gas cars as illegal, nowadays, domestic authorities also encourage the public to replace gasoline with gas as fuels for supplying millions of vehicles and plan to widely set up gas filling stations as well as subsidize the public to convert their cars to use gas so as to achieve the purpose of universalizing the gas cars. However, gas cars are prone to explode when they move on the road, which is a problem to be solved.

It is known that the cars modified to use liquefied petroleum gas (LPG) are also known as gas vehicles, and the bi-fuel vehicles are the cars which can use petrol fuel or LPG fuel. Currently on the market, the so called bi-fuel vehicles are all provided with a dual fuel system which can switch to use petrol fuel or LPG fuel. In the gas vehicles, the structures of the steel cylinders for storing LPG must be much rigid and impact resistant than the oil tanks. In general, a steel plate of the main girder of a car has a thickness of 1.1 mm while the LPG steel cylinder has a thickness of 3 mm. The LPG steel cylinders can be divided into two types including horizontal-form and vertical-form steel cylinders depending on the size of the installation space. In order not to affect the luggage space, the horizontal-form steel cylinders are usually adopted to use in the gas vehicles.

In terms of the structure of a LPG high-pressure steel cylinder, it mainly composed of a fill valve, an output valve, a safety valve, a liquid level indicator and the like. Furthermore, a LPG steel cylinder is also provided with various kinds of safety valves. The LPG steel cylinders have ability of automatic filling 80% of gas in themselves and can bear pressure of more than 30 kg/cm², so they are rigid and durable. Though the tested and certified LPG steel cylinders have much safety design than the oil tanks, they still have many problems to be solved. For instance, it is difficult to control quality of the steel cylinders due to being manufactured by welding, and there is still a need to increase the usage security of the gas vehicles.

### SUMMARY OF THE INVENTION

In view of the above-mentioned problems, the object of the present invention is to provide a gas steel cylinder structure for cars which has structural strength and no air leaks in use.

Disclosed herein is a gas steel cylinder structure for cars. It comprises a gas steel cylinder having an inner cylinder body and an outer cylinder body integrally formed thereof, wherein the inner cylinder body is provided with a through hole for communicating with the outer cylinder body; an upper lid; and a top lid. Accordingly, the gas steel cylinder structure of the present invention has structural strength and may not be subject to air leaks in use, which achieve efficacy of usage security, simplified manufacturing procedures, and cost reduction.

According to an embodiment of the present invention, the upper lid has a first locking portion correspondingly sealed at an opening of the gas steel cylinder, and the upper lid is provided with a perforation in the middle thereof for the inner cylinder body to penetrate therethrough.

According to an embodiment of the present invention, an opening of the outer cylinder body of the gas steel cylinder is provided with a first bonding portion for locking on the first locking portion of the upper lid, and an opening of the inner cylinder body of the gas steel cylinder is provided with a second bonding portion for locking on the top lid.

According to an embodiment of the present invention, the top lid has an inserting section relative to the perforation of the upper lid, and the inserting section is provided with a second locking portion for correspondingly locking on the second bonding portion of the inner cylinder body.

According to an embodiment of the present invention, the first locking portion of the upper lid is provided with a first sealing pad relative to the first bonding portion of the outer cylinder body of the gas steel cylinder, the second locking portion of the inserting section of the top lid is provided with a second sealing pad relative to the second bonding portion of the inner cylinder body of the gas steel cylinder, and the inserting section of the top lid is provided with a third sealing pad relative to the perforation of the upper lid. In such a case, the first sealing pad, the second sealing pad and the third sealing pad can prevent gas leaking out of the gas steel cylinder.

According to an embodiment of the present invention, the gas steel cylinder is made of aluminum, magnesium or aluminum-magnesium alloy.

### BRIEF DESCRIPTION OF THE DRAWINGS

FIG. 1 is a perspective exploded view showing a gas steel cylinder structure for cars according to the present invention;

FIG. 2 is a stereogram showing a gas steel cylinder structure for cars according to the present invention;

FIG. 3 is a sectional view showing a gas steel cylinder structure for cars according to the present invention.

### DETAILED DESCRIPTION OF THE PREFERRED EMBODIMENT

Hereinafter, an exemplary embodiment of the present invention will be described in detail with reference to the accompanying drawings.

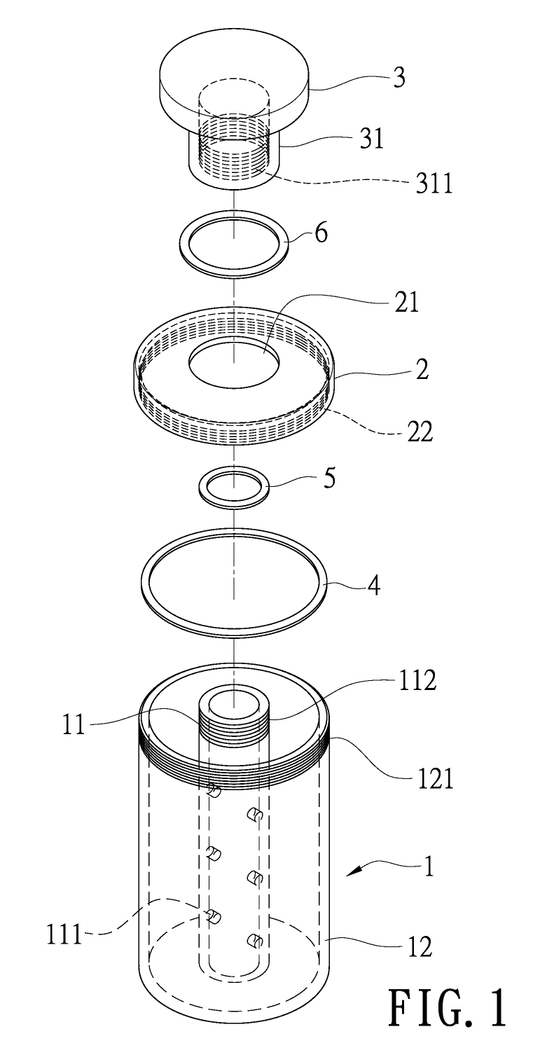

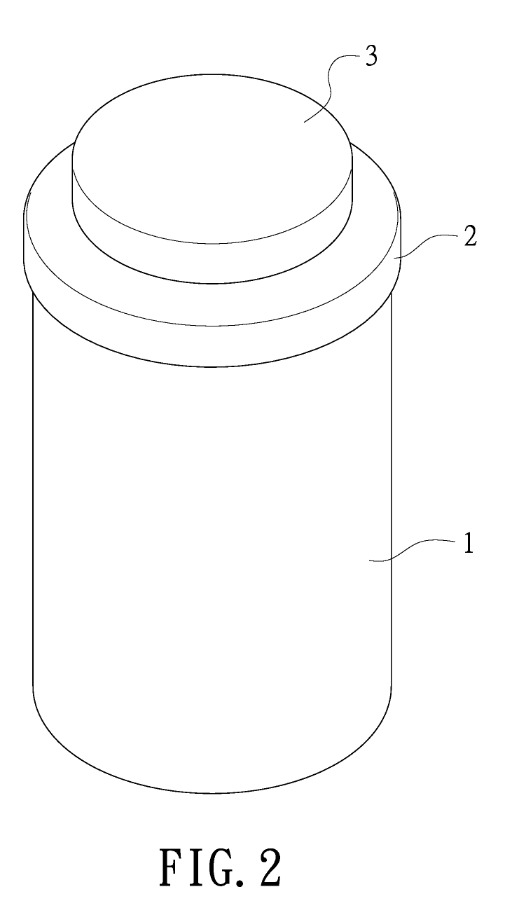

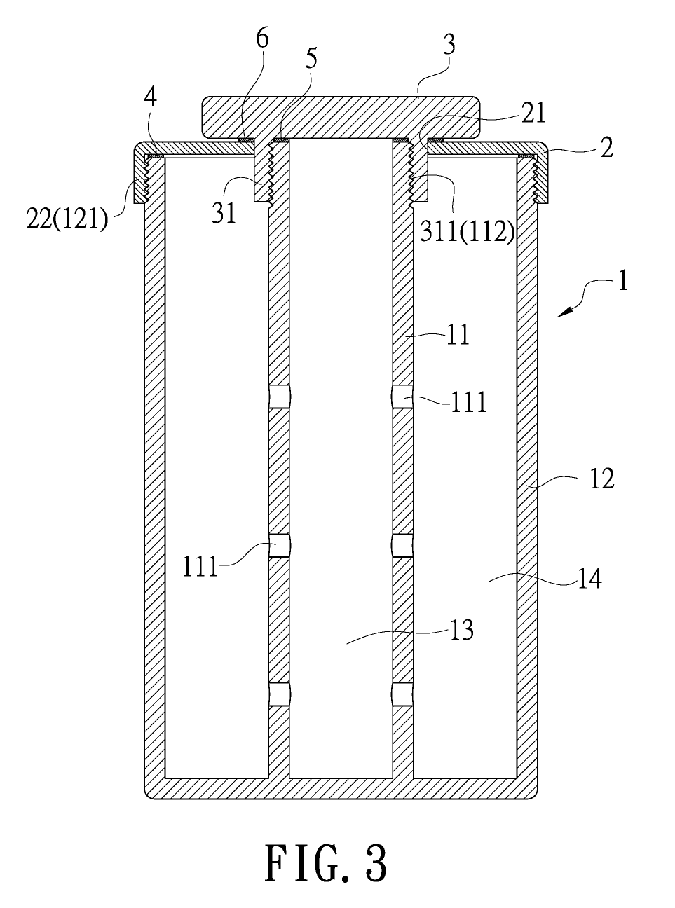

As showed in FIGS. 1-3, a gas steel cylinder structure for cars comprises:

a gas steel cylinder (1) having an inner cylinder body (11), an outer cylinder body (12), a first chamber (13) disposed in a middle of the inner cylinder body (11), and a second chamber (14) between the inner cylinder body (11) and the outer cylinder body (12), wherein the inner cylinder body (11) is integrally forged with the outer cylinder body (12) and provided with a through hole (111) for communicating the first chamber (13) with the second chamber (14);

an upper lid (2) correspondingly sealed on the gas steel cylinder (1), wherein the upper lid (2) is provided with a perforation (21) in the middle thereof for the inner cylinder body (11) to penetrate therethrough; and

a top lid (3) having an inserting section (31) relative to the perforation (21) of the upper lid (2) for penetrating the perforation (21) and correspondingly locking on the inner cylinder body (11).

In use of the gas steel cylinder structure for cars as showed in FIGS. 1-3, the gas steel cylinder (1) is preferentially manufactured by aluminum, magnesium or aluminum-magnesium alloy. An opening of the outer cylinder body (12) of the gas steel cylinder (1) is provided with a first bonding portion (121), and an opening of the inner cylinder body (11) is provided with a second bonding portion (112). An inner margin of the upper lid (2) is provided with a first locking portion (22) for correspondingly locking on the first bonding portion (121), and the first locking portion (22) of the upper lid (2) is provided with a first sealing pad (4) relative to the first bonding portion (121) of the outer cylinder body (12) of the gas steel cylinder (1). In assembling the gas steel cylinder structure for cars, the inner cylinder body (11) penetrates into the perforation (21) of the upper lid (2) when the upper lid (2) is locked on the outer cylinder body (12) of the gas steel cylinder (1), and then the inserting section (31) of the top lid (3) is correspondingly locked on the second bonding portion (112) of the inner cylinder body (11) for covering on the upper lid (2). The inserting section (31) is further provided with a second locking portion (311) for correspondingly locking on the second bonding portion (112) of the inner cylinder body (11) so as to bond the top lid (3) to the gas steel cylinder (1). Moreover, the second locking portion (311) of the inserting section (31) of the top lid (3) is provided with a second sealing pad (5) relative to the second bonding portion (112) of the inner cylinder body (11) of the gas steel cylinder (1), and the inserting section (31) is provided with a third sealing pad (6) relative to the perforation (21) of the upper lid (2). In such a case, the first sealing pad (4), the second sealing pad (5) and the third sealing pad (6) can prevent gas leaking out of the gas steel cylinder (1).

The top lid (3) is further provided with a plurality of valve mechanisms (not shown in FIGS. 1-3) for inputting and outputting gas. Accordingly, the whole gas steel cylinder structure has structural strength and may not be subject to air leaks in use.

Compared with the technique available now, the present invention has the following advantages:

1. The inner cylinder body is integrally forged with the outer cylinder body, so the gas steel cylinder structure of the present invention has structural strength and no air leaks in use, which increases the usage security of the gas vehicles.

2. The design of the plural sealing pads can prevent gas leaking out of the gas steel cylinder structure which increases the usage security of the gas vehicles.

3. The inner cylinder body is integrally forged with the outer cylinder body, so the gas steel cylinder structure of the present invention achieves efficacy of simplified manufacturing procedures and cost reduction.

What is claimed is:

1. A gas steel cylinder structure for cars, comprising:
a gas steel cylinder having an inner cylinder body, an outer cylinder body, a first chamber disposed in a middle of the inner cylinder body, and a second chamber between the inner cylinder body and the outer cylinder, wherein the inner cylinder body is integrally forged with the outer cylinder body and provided with a through hole for communicating the first chamber with the second chamber;
an upper lid correspondingly sealed on the gas steel cylinder, wherein the upper lid is provided with a perforation in the middle thereof for the inner cylinder body to penetrate therethrough; and
a top lid having an inserting section relative to the perforation of the upper lid for penetrating the perforation and correspondingly locking on the inner cylinder body.

2. As the gas steel cylinder structure for cars claimed in claim 1, wherein an opening of the outer cylinder body of the gas steel cylinder is provided with a first bonding portion, and an inner margin of the upper lid is provided with a first locking portion for correspondingly locking on the first bonding portion.

3. As the gas steel cylinder structure for cars claimed in claim 1, wherein an opening of the inner cylinder body of the gas steel cylinder is provided with a second bonding portion, and the inserting section is provided with a second locking portion for correspondingly locking on the second bonding portion.

4. As the gas steel cylinder structure for cars claimed in claim 2, wherein an opening of the inner cylinder body of the gas steel cylinder is provided with a second bonding portion, and the inserting section is provided with a second locking portion for correspondingly locking on the second bonding portion.

5. As the gas steel cylinder structure for cars claimed in claim 4, wherein the first locking portion of the upper lid is provided with a first sealing pad relative to the first bonding portion of the outer cylinder body of the gas steel cylinder.

6. As the gas steel cylinder structure for cars claimed in claim 5, wherein the second locking portion of the inserting section of the top lid is provided with a second sealing pad relative to the second bonding portion of the inner cylinder body of the gas steel cylinder.

7. As the gas steel cylinder structure for cars claimed in claim 6, wherein the inserting section of the top lid is provided with a third sealing pad relative to the perforation of the upper lid.

8. As the gas steel cylinder structure for cars claimed in claim 7, wherein the gas steel cylinder is made of aluminum, magnesium or aluminum-magnesium alloy.
